(19) United States
(12) Patent Application Publication
(10) Pub. No.: US 2008/0233938 A1
(43) Pub. Date: Sep. 25, 2008

(54) MARITIME RADIO INTERFERENCE MANAGEMENT USING POSITION AND RADIO FREQUENCY SPECTRAL ENERGY DETECTION

(75) Inventors: Anthony J. Bradley, Renton, WA (US); Thanaroj Narkmon, Issaquah, WA (US); Kenneth J. Ellis, Sammamish, WA (US)

Correspondence Address: DARBY & DARBY P.C., P.O. BOX 770, Church Street Station, New York, NY, 10008-0770, US

(73) Assignee: SeaMobile, Inc., Seattle, WA (US)

(21) Appl. No.: 12/035,400

(22) Filed: Feb. 21, 2008

Related U.S. Application Data
(60) Provisional application No. 60/890,978, filed on Feb. 21, 2007.

(51) Int. Cl. H04M 3/22

(52) U.S. Cl. 455/418

(57) ABSTRACT

Embodiments are directed to avoiding interference between a maritime mobile radio network and a mobile radio network provided at a fixed position relative to the maritime mobile radio network. A current geographic position of the maritime network is determined. A minimum separation distance to be maintained between the two networks is determined based on the geographic position. A current separation distance is predicted based a signal detected from the fixed-position network. When the predicted separation distance is less than the minimum separation distance and the detected signal is determined to be persistent, the maritime network is turned off. The detected signal may be determined to be persistent when it is continuously detected over a predetermined time period and has sufficient signal energy for sustaining a cellular telephone call.

### CROSS-REFERENCE TO RELATED APPLICATIONS

This Application is a Non-Provisional of, and claims priority under 35 USC 119(e) to Provisional application No. 60/890,978 filed on Feb. 21, 2007, the entire contents of which are hereby incorporated by reference.

### FIELD OF ART

This invention relates to a method of managing a radio network that has a mobile infrastructure, and more specifically is directed to avoid interfering with fixed infrastructure mobile radio networks.

### BACKGROUND

Mobile radio networks have traditionally been implemented with fixed, land-based facilities. While passengers having cellular telephones aboard maritime vessels have had access to such land-based mobile networks when their vessels were present within the service boundaries of these networks (for example, when in port or otherwise sufficiently close to a coastline), there has been a need to provide additional mobile network infrastructure to enable mobile communications aboard maritime vessels that are not within the service boundaries of a land-based mobile network.

Some maritime mobile radio infrastructures seek to avoid conflicts between land-based mobile radio networks and maritime mobile radio networks in proximity by selectively controlling the operating frequencies used by the maritime mobile radio networks to avoid conflict with the land-based mobile radio networks. An industry association called the GSM Association's Billing and Accounting Rapporteur Group (BARG) further proposed that maritime mobile radio networks be required to be non-interfering with land-based mobile radio networks at any distance nearer than 12 miles from the shore line of the land-based networks.

Some maritime mobile radio network service providers turn off their onboard mobile radio systems when their vessels are positioned within this 12 mile limit. This approach however is inefficient. For example, land-based mobile radio service providers typically do not have facilities with active coverage that extends 12 miles from all shore lines. In addition, some geographic localities have adopted alternative rules in regard to distance limits. For example, a number of Mediterranean ports have adopted a 3 mile limit, rather than a 12 mile limit. As a result, it is difficult for maritime mobile operators to determine when it is appropriate to turn on or off a maritime mobile radio network according to rules prescribed for a particular geographic location, and for the characteristics of land-based mobile radio networks actually in use at that location.

### BRIEF DESCRIPTION OF THE DRAWINGS

Non-limiting and non-exhaustive embodiments of the present invention are described with reference to the following drawings. In the drawings, like reference numerals refer to like parts throughout the various figures unless otherwise specified.

For a better understanding of the present invention, reference will be made to the following Detailed Description of the Invention, which is to be read in association with the accompanying drawings, wherein:

FIG. 1 is a block diagram depicting a maritime mobile radio infrastructure;

FIG. 2 is a flow diagram depicting a method of operation for a maritime radio interference management system that is consistent with principles of the present invention; and

FIG. 3 shows a functional block diagram of an example base station according to one embodiment of the invention.

### DETAILED DESCRIPTION OF EMBODIMENTS

The present invention will now be described with reference to the accompanying drawings, which form a part hereof, and which show, by way of illustration, specific exemplary embodiments by which the invention may be practiced. This invention may, however, be embodied in many different forms and should not be construed as limited to the embodiments set forth herein; rather, these embodiments are provided so that this disclosure will be thorough and complete, and will fully convey the scope of the invention to those skilled in the art. Among other things, the present invention may be embodied as methods or devices. Accordingly, the present invention may take the form of an entirely hardware embodiment, an entirely software embodiment or an embodiment combining software and hardware aspects. The following detailed description is, therefore, not to be taken in a limiting sense.

Throughout the specification, the term “connected” generally means a direct connection between the things that are connected, without any intermediary devices or components, but may mean establishing communications between things that are coupled with intermediary devices. The term “coupled,” or “in communication with” means a direct connection between the things that are connected, or an indirect connection through one or more either passive or active intermediary devices or components. The meaning of “a,” “an,” and “the” include plural references. The meaning of “in” includes “in” and “on.” The term “or” is an inclusive “or” operator, and includes the term “and/or,” unless the context clearly dictates otherwise. The phrase “in one embodiment,” as used herein does not necessarily refer to the same embodiment, although it may. Similarly, the phrase “in another embodiment,” as used herein does not necessarily refer to a different embodiment, although it may. The term “based on” is not exclusive and provides for being based on additional factors not described, unless the context clearly dictates otherwise. The term “user” can include a mobile device user, an online service subscriber, a computer user, and/or other person using an electronic device. The term “message” can include a copy of a message.

Briefly stated, embodiments of the invention are described for avoiding interference between a movable mobile radio network (for example, a mobile radio network installed on a maritime vessel) and a mobile radio network provided at a fixed position relative to the movable mobile radio network (for example, near a port). An example embodiment includes: a) determining a current geographic position of the movable mobile radio network, b) based on the current geographic position, determining a minimum separation distance to be maintained between the movable mobile radio network and the fixed-position mobile radio network while the movable mobile radio network is operating, c) detecting a radio signal originating outside of the movable mobile radio network, d) determining a predicted separation distance based on the signal strength of the detected radio signal, e) monitoring the detected radio signal when the predicted separation distance is less than the minimum separation distance, and f) turning off the movable mobile radio network when the monitored radio signal is determined to be persistent. In one embodiment of the present invention, the monitored radio signal is persistent when, over a predetermined number of scanning cycles or a predetermined scanning period, the radio signal is continuously detected and has sufficient signal energy as detected for sustaining a cellular telephone call. Many other embodiments will be apparent to those of ordinary skill in the art.

### Illustrative Operating Environment

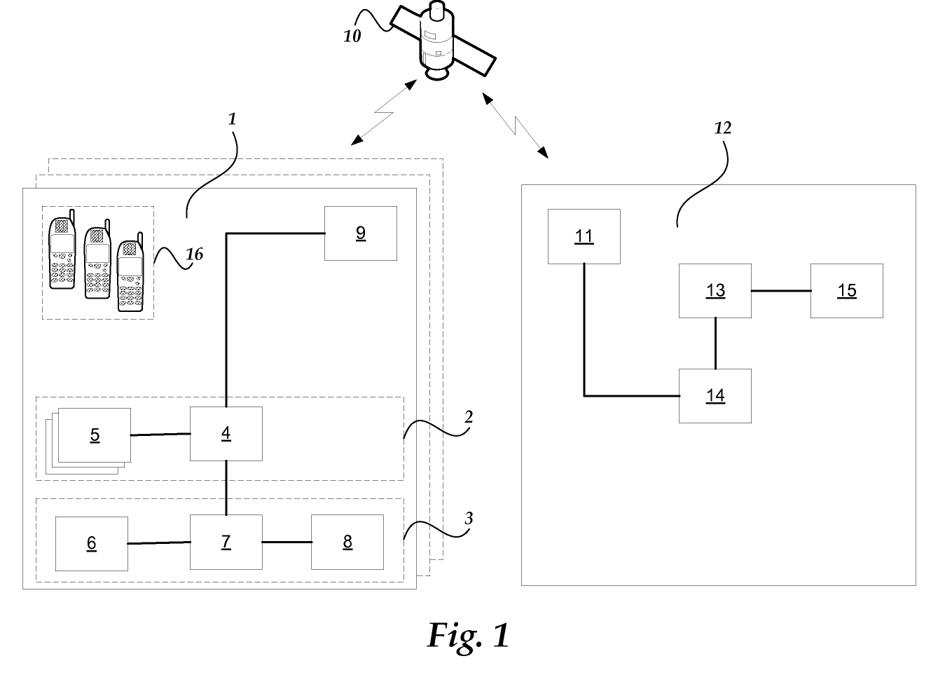

FIG. 1 provides a block diagram illustrating a maritime mobile radio infrastructure. The diagram illustrates a mobile radio infrastructure based on the Global System for Mobile Communications (GSM), but is also applicable to other radio systems (for example, including time-division-multiple-access (TDMA), code-division-multiple access (CDMA), wideband code-division-multiple access (WCDMA), Universal Mobile Telecommunication System (UMTS) mobile radio infrastructures, and the like).

The maritime mobile radio infrastructure of FIG. 1 includes land-based common resources 12, onboard radio and control systems 1, and a satellite link 11. Satellite link gateways 9 and 10 are coupled to satellite link 11 to connect the onboard radio and control systems 1 with the common resources 12. Common resources 12 will typically include, for example, a network interface 14, which may include one or more components, including a mobile switching center (MSC), visiting location register (VLR) and home location register (HLR). Network interface 14, together with satellite link 11, enable communications to be established between the onboard radio and controls systems 1 of the maritime radio network and one or more of public networks 13, public cellular networks 15, or other moving radio networks such as another maritime radio network.

Embodiments of radio and control systems 1 further include two primary parts. A radio network 2 enables onboard communication among mobile devices, such as cellular telephones 16 on the vessel. Radio network 2 also enables ship-to-shore communication between the cellular telephones 16 and other cellular or fixed network telephones on land. In addition, control system 3 controls and adapts the radio network 2 according to its surroundings.

The radio network 2 further includes one or more base stations 5, which handle direct radio communication to and from the cellular telephones 16, and a base station controller 4 that administers the base stations 5 (for example, by determining their frequency configurations). The base station controller 4 is connected to the common MSC, VLR and HLR 14 via the satellite links 9, 10, 11. Calls may be set up over the satellite link elements 9, 10, 11 using standard cellular network procedures for the common resources 12.

The control system 3 includes a radio sensor 8, a positioning system 6 (for example, a conventional global positioning system (GPS) position sensing device) used to acquire the geographic position of the vessel, and a control server 7 for adaptively running the radio network 2. According to an embodiment of the present invention, the radio sensor 8 comprises a spectrum analyzer which is capable of measuring signal energies in various frequency bands to determine, for example, whether the detected land-based network is a GSM network, a TDMA network or the like. For the purposes of the present invention, the control server 7 is capable at least to instruct the base station controller 4 to turn the radio network 2 on and off.

According to an embodiment of the present invention, the control server 7 further comprises a database containing rule-based information by geographic location (for example, specifying minimum non-interference distances from shore line according to port or point location). Control server 7 may, for example, be implemented as a conventional general-purpose computing server, running stored programs on one of a variety of conventional operating systems (for example, LINUX).

### Illustrative Process Flows

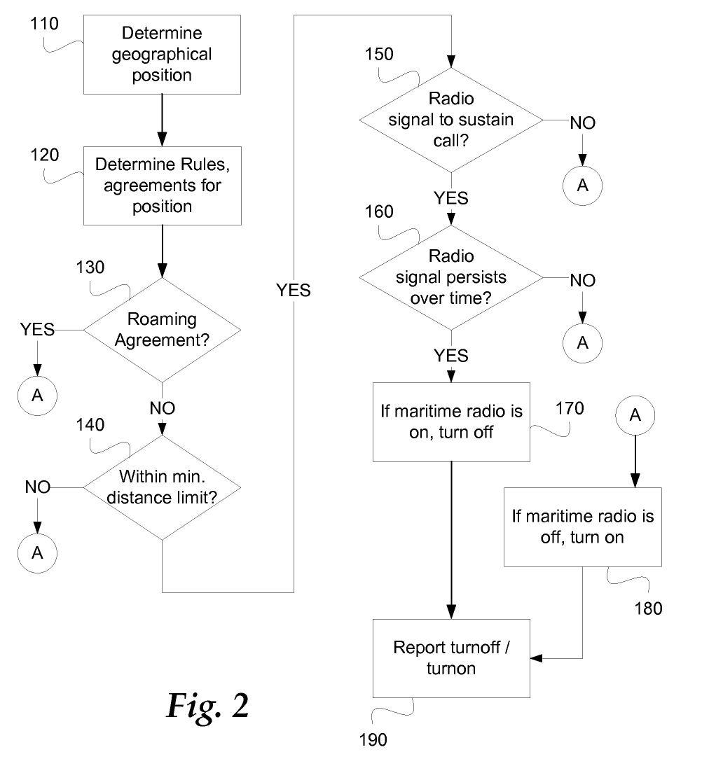

FIG. 2 provides a flow diagram illustrating an example method of operation of a maritime radio interference management system in accordance with principles of the present invention. In one embodiment, the illustrated method may be implemented as a stored program running on the control server 7 of FIG. 1.

As indicated in FIG. 2, this example method begins at step 110 with the control server 7 of FIG. 1 instructing the positioning system 6 to determine a current geographical position of the maritime vessel. Based on the determined current geographical position, the control server 7 queries its database at step 120 to determine current rules and agreements associated with the current position. For example, current rules and agreements may include a minimum non-interference distances from shore line, and a roaming agreement between the provider of the maritime radio network and a land-based radio network provider with service extending to the current geographic location.

At step 130 of FIG. 2, the control server 7 determines whether or not an applicable roaming agreement exists. If so, the control server 7 proceeds to step 180 to determine whether the vessel's mobile radio network is currently off, and if so, proceeds to instruct the base station controller 4 to turn on the network. If no applicable roaming agreement exists, the control server proceeds to step 140.

At step 140, the control server 7 queries the radio sensor 8 to determine whether an off-ship radio signal (for example, a GSM radio signal) has been detected which could interfere with the maritime radio network, and if so, whether the signal strength, or other characteristic of the detected signal indicates that the maritime vessel is likely at a distance less than the minimum non-interference distances from shore line. If no signal has been detected or the detected signal indicates that the vessel is not likely at less than the minimum distance, the controller server 7 proceeds to step 180. Otherwise, the control server 7 proceeds to step 150.

At step 150, the control server 7 determines whether the energy in the detected signal is sufficient to sustain a cellular telephone call at the current geographical location of the vessel. If not, the control server 7 proceeds to step 180. Otherwise, the control server 7 proceeds to step 160. At step 160, the control server 7 instructs the radio sensor 8 to scan again for the detected signal over a predetermined time period or a predetermined number of scanning cycles to determine whether or not the detected signal is persistent. During its rescanning, the control server 7 may further confirm whether or not the signal persists in the same communication channels at a signal strength sufficient to sustain a call from the current geographic location. In addition, the control server 7 may instruct the radio sensor 8 to determine whether or not the detected signal is associated with an identifiable and common set of radio channels over the scanning period. If the detected signal is persistent, the control server 7 proceeds at step 170 to determine whether the maritime radio network is on, and if so, instructs the base station controller 4 to turn off the maritime network.

At this point, the control server 7 may also determine whether any conflicts are suggested by the current geographical position data and the off-ship radio signal data. For example, control server 7 may determine, based on the geographic position data, that a detected off-ship radio signal is an errant signal. For instance, if the geographic position data indicates that the maritime vessel is at a substantial distance away from any shore line near land-based radio networks. In this case, the control server 7 may begin another cycle of the disclosed method at step 110 without further action.

At or prior to the completion of either of steps 170 and 180, the control server 7 at step 190 preferably uses the maritime radio network to report details for any turnoff/turnon event to a centralized server of the maritime radio network service provider, and/or logs these details in its own database for future reporting. Control server 7 may also report or log other associated data (for example, data regarding apparent conflicts). In either case, off-line data analysis can be performed to determine, for example, whether rules associated with the current position should be modified or otherwise updated.

In one embodiment, maritime interference management incorporates a programmed “hysteresis” in its response, to reduce the likelihood that the maritime radio network will be turned off and on, in response to transient conditions. For example, as discussed above with reference to step 160, the control server 7 may be set to prevent the on-board network from being turned off unless a detected off-ship radio signal persists for a predetermined period of time. Conversely, the control server 7 may be set to prevent the on-board network from being turned on unless conditions warranting the turn on, persist for a predetermined period of time. In addition, the control server 7 may not allow the network to be turned off without further analysis if a detected off-ship signal conflicts with an expectation, based on the geographic position data.

### Illustrative Controller

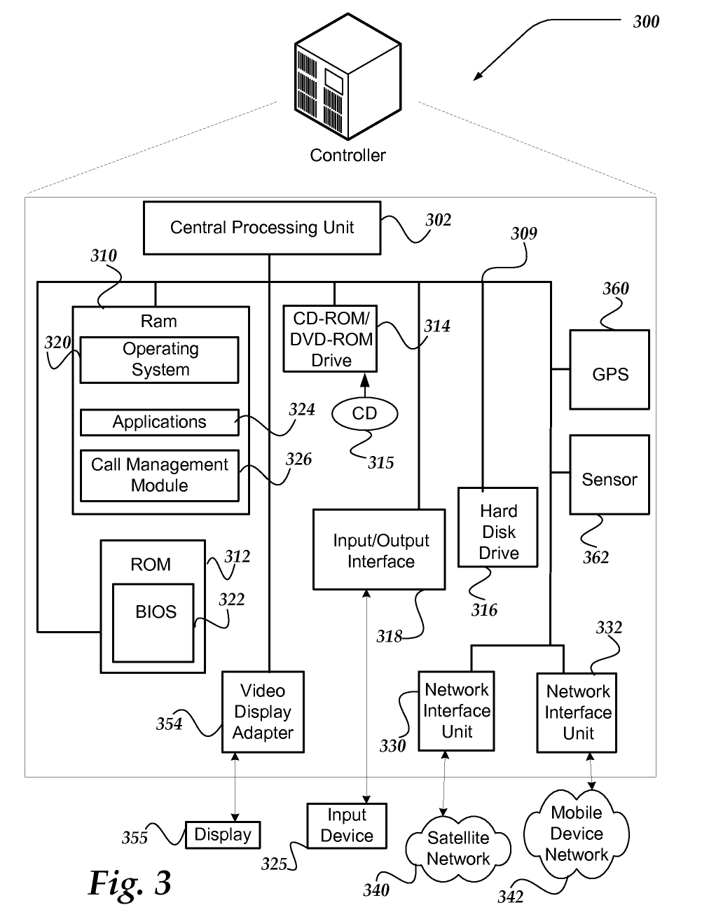

FIG. 3 shows a functional block diagram of an example controller, such as control server 7, according to one embodiment of the invention. This example base station is configured similar to a computing device to enable a variety of processes. Other embodiments may comprise a specialized device with more limited capabilities. Base station 300 includes a processing unit 302, network interface units 330 and 332, and a mass memory, all in communication with each other via a bus 309. The mass memory generally includes RAM 310, ROM 312, and one or more permanent mass storage devices, such as an optical drive 314 that can read a machine readable medium such as a CD 315, a hard disk drive 316, a tape drive, a floppy disk drive, and/or the like. The mass memory stores an operating system 320 for controlling the operation of base station 300. A general-purpose operating system or a specialized operating system may be employed. In addition, or alternatively, a basic input/output system (“BIOS”) 322 is also provided for controlling low-level operation of base station 300.

The mass memory also includes machine-readable media, such as volatile, nonvolatile, removable, and non-removable media implemented in any method or technology for storage of information, such as machine readable instructions, data structures, program modules, parameter settings, and/or other data. Examples of machine-readable media include RAM, ROM, EEPROM, flash memory, or other memory technology, CD-ROM, digital versatile disks (DVD), or other optical storage, magnetic cassettes, magnetic tape, magnetic disk storage, or other magnetic storage devices, or any other medium which can be used to store the desired information and which can be accessed by an electronic device.

The mass memory also stores program code and data. One or more applications 324 are loaded into mass memory and run on operating system 320. Examples of application programs include configuration management programs, database programs, schedulers, transcoders, statistical analysis programs, and the like. Other applications may include data loggers, error processors, email programs, calendars, web services, word processing programs, spreadsheet programs, and so forth. Mass storage further includes applications such as a call management module 326 for managing communications between client devices and a satellite communications node. Call management module 326 may also include, or interface with a database for storing data, such as a signal strength threshold, an interference threshold, distance data, agreement data, roaming data, geographic location data, and/or other information.

Base station 300 may also includes a video display adapter 354 that can drive a display 355, and may include an input/output interface 318 for communicating with external devices, such as a mouse, keyboard, scanner, or other input device 325. Base station 300 can communicate with a local network, the Internet, a telephone network, or some other communications network via network interface units 330 and 332, which are constructed for use with various communication protocols including code division multiple access (CDMA), time division multiple access (TDMA), global system for mobile communications (GSM), Institute for Electrical and Electronics Engineers (IEEE) 802.11, IEEE 802.16 (WiMax), SMS, general packet radio service (GPRS), Wireless Application Protocol (WAP), transmission control protocol/Internet protocol (TCP/IP), user datagram protocol (UDP), and the like. Network interface units 330 and 332 are sometimes known as transceivers, transceiving devices, network interface cards (NICs), and the like. The network interface units can facilitate communications between communication carriers, client communication devices, and/or computing devices that conform to the same or differing communication protocols. For example, network interface units 330 and 332 are illustrated as communicating with a satellite network 340 and a mobile device network 342, as described above.

Controller 300 may also include a GPS transceiver 360 and/or a radio sensor 362. GPS transceiver 360 can determine the physical coordinates of controller 300 on the surface of the Earth, and typically outputs a location as latitude and longitude values. GPS transceiver 360 can also employ other geo-positioning mechanisms, including, but not limited to, triangulation, assisted GPS (AGPS), Enhanced Observed Time Difference (E-OTD), cell identifier (CI), service area identifier (SAI), enhanced timing advance (ETA), base station subsystem (BSS), or the like, to further determine the physical location of controller 300 on the surface of the Earth. It is understood that under different conditions, GPS transceiver 360 can determine a physical location within millimeters for controller 300; and in other cases, the determined physical location may be less precise, such as within a meter or significantly greater distances.

Embodiments of the present invention have been set forth in detail in this description, which is to be taken as a whole, to provide a more thorough understanding of the invention. In some instances, well-known features have not been described in detail, so as to not obscure unnecessarily the invention. Some embodiments of the present invention may include features such as those disclosed in International Patent Publication No. WO 2005/067324 A1 to Flysveit et al. (“the '324 Publication”), which was published on Jul. 21, 2005 and is incorporated by reference in its entirety herein. The '324 Publication discloses a mobile radio infrastructure for use aboard maritime vessels. The mobile radio infrastructure disclosed by the '324 Publication includes a mobile radio network placed onboard the maritime vessel which enables communications between the cellular telephones of passengers aboard the vessel, an interface (for example, a satellite interface) for linking the maritime mobile network with a land-based mobile network, and a control system for controlling the maritime mobile radio network according to its surroundings. The control system of the '324 Publication includes a database containing information about radio frequency regulations and assigned radio frequencies in different geographic areas, and a positioning system for determining a current geographic position of the maritime vessel. The control system uses information from the database and current geographic position information to determine allowable radio frequencies that can be used by the onboard mobile radio network at the current geographic position.

In addition, or alternatively, some embodiments of the present invention may use features such as those disclosed in U.S. Patent Publication No. 2002/0072328 A1 (“the '328 Publication”), which was published on Jun. 13, 2002 and is incorporated by reference in its entirety herein. The '328 Publication also discloses a maritime mobile radio infrastructure including a mobile radio network placed onboard the maritime vessel, an interface for linking the maritime mobile network with a land-based mobile network, and a control system for controlling the maritime mobile radio network according to its surroundings. The control system of the '328 Publication scans the radio spectrum surrounding the maritime vessel to identify control channel signals land-based mobile networks. When the control channel signal of a land-based mobile radio network is detected, indicating that the mobile radio infrastructure is within the service area of the land-based mobile radio network, the control system of the maritime mobile radio infrastructure initiates a negotiation between the onboard mobile radio network and the detected land-based mobile radio network for a direct radio link to be set up between the two networks. In this mode, available frequencies of the land-based mobile radio network are shared by the two networks, under the control of the land-based mobile radio network.

Embodiments of the invention may include all combinations and subcombinations of the various elements, features, functions and/or properties disclosed herein. The following claims define certain combinations and subcombinations, which are regarded as novel and non-obvious. Additional claims for other combinations and subcombinations of features, functions, elements and/or properties may be later presented in this or in a related application. The invention is not intended to be limited by the description as provided above, but rather is intended to be defined by the claims as presented below.

What is claimed as new and desired to be protected by Letters Patent is:

1. A controller for controlling a movable mobile radio network, comprising:
a processor,
a communication interface coupled to the processor;
a position module coupled to the processor;
a signal detector coupled to the processor; and
a memory coupled to the processor and storing processor readable instructions that cause the processor to perform a plurality of operations, including:
determining a current geographic position of the movable mobile radio network;
determining a minimum separation distance to be maintained between the movable mobile radio network and a fixed-position mobile radio network while the movable mobile radio network is turned on, based on the current geographic position;
detecting a radio signal originating outside of the movable mobile radio network;
determining a predicted separation distance between the movable mobile radio network and the fixed-position mobile radio network, based on a measured signal strength of the detected radio signal;
monitoring the detected radio signal when the predicted separation distance is less than the minimum separation distance; and
turning off the movable mobile radio network when the monitored radio signal is determined to be persistent.

2. The controller of claim 1, wherein the instructions further cause the processor to perform the operation of scanning with the signal detector over a predetermined number of scanning cycles to detect the predetermined radio signal, wherein the monitored radio signal is determined to be persistent when detected in each of the predetermined number of scanning cycles.

3. The controller of claim 1, wherein the monitored radio signal is determined to be persistent when the monitored radio signal has sufficient energy in each detected scanning cycle to sustain a cellular telephone call.

4. The controller of claim 1, wherein the radio signal is detected as being associated with one or more radio channels during the detecting step, and wherein the monitored radio signal is determined to be persistent when energy of the radio signal is detected for each of the one or more radio channels in each detected scanning cycle.

5. A method for avoiding interference between a movable mobile radio network and a mobile radio network provided at a fixed position relative to the movable mobile radio network, the method comprising the steps of:
determining a current geographic position of the movable mobile radio network;
determining a minimum separation distance to be maintained between the movable mobile radio network and the fixed-position mobile radio network while the movable mobile radio network is turned on, based on the current geographic position;
detecting a radio signal originating outside of the movable mobile radio network;
determining a predicted separation distance between the movable mobile radio network and the fixed-position mobile radio network, based on a measured signal strength of the detected radio signal;
monitoring the detected radio signal when the predicted separation distance is less than the minimum separation distance; and
turning off the movable mobile radio network when the monitored radio signal is determined to be persistent.

6. The method of claim 5, wherein the monitoring step further comprises the step of:
scanning with a signal detector over a predetermined number of scanning cycles to detect the predetermined radio signal, wherein the monitored radio signal is determined to be persistent when detected in each of the predetermined number of scanning cycles.

7. The method of claim 6, wherein the monitored radio signal is determined to be persistent when the monitored radio signal has sufficient energy in each detected scanning cycle to sustain a cellular telephone call.

8. The method of claim 6, wherein the radio signal is detected as being associated with one or more radio channels during the detecting step, and wherein the monitored radio signal is determined to be persistent when energy of the radio signal is detected for each of the one or more radio channels in each detected scanning cycle.

9. A processor readable medium storing instructions that cause a processor to perform the operations of claim 6.
